(19) United States
(12) Patent Application Publication
(10) Pub. No.: US 2013/0104511 A1
(43) Pub. Date: May 2, 2013

(54) STEPPED OR LABYRINTH SEAL AND SPINDLE ASSEMBLY USING SAME

(71) Applicant: EXMARK MANUFACTURING COMPANY, INCOR, Beatrice, NE (US)

(72) Inventors: Timothy D. Andre, Firth, NE (US); Patrick D. Sands, Virginia, NE (US)

(73) Assignee: EXMARK MANUFACTURING COMPANY, INCORPORATED, Beatrice, NE (US)

(21) Appl. No.: 13/652,714

(22) Filed: Oct. 16, 2012

Related U.S. Application Data
(60) Provisional application No. 61/551,573, filed on Oct. 26, 2011.

(51) Int. Cl. F16C 33/80; A01D 67/00

(52) U.S. Cl. 56/320.1; 384/480

(57) ABSTRACT

A spindle assembly for use with a rotating member is provided. The spindle assembly may include a flexible shield or seal that, in one embodiment, is radially and axially secured to one end of a spindle shaft of the assembly. The seal may be spaced-apart from one or more bearings rotationally supporting the shaft. As a result, a space between the seal and the bearing may be provided that allows dissipation of energy from a fluid (e.g., pressurized stream of cleaning fluid) that is forced past the seal. Moreover, spindle assembly constructions in accordance with embodiments of the instant invention may permit increased bearing spacing, potentially reducing bearing load and increasing bearing life.

### RELATED APPLICATION(S)

This application claims the benefit of U.S. Prov. Appl. No. 61/551,573, filed Oct. 26, 2011, the content of which is incorporated herein by reference in its entirety.

### TECHNICAL FIELD

Embodiments of the present invention relate generally to rotating spindles or shafts, and, more particularly, to a protective stepped or “labyrinth” shield or seal for use with a rotating shaft such as that used with a lawn mower cutting deck spindle.

### BACKGROUND

Lawn mowers utilizing one or more rotating blades coupled to a cutting deck are known. The blades are, when selectively powered, generally operable to cut grass and other vegetation over which the cutting deck passes.

With multiple-blade decks, such as those found on many wide area (riding and walk-behind) mowers, each cutting blade is typically attached to a lower end of a vertically-oriented spindle shaft that passes through an upper surface or wall of a housing of the deck. The spindle shaft may be supported for rotation by bearings contained within a spindle housing, which is, in turn, attached to the upper wall. An upper end of the spindle shaft, which protrudes above the upper wall, may have attached thereto a driven sheave. During operation, an engine powers a drive belt that provides power to the driven sheave. The sheave, in turn, rotates the spindle shaft and thus the cutting blade.

To achieve optimal cutting, typical mower spindles may rotate at speeds exceeding 2,000 revolutions per minute (RPM). Moreover, in some applications (e.g., commercial/landscape contracting), mowers may operate continuously for extended periods. Accordingly, it is desirable to ensure that the spindle bearings remain adequately lubricated.

While manufacturers of some spindle configurations recommend periodic spindle lubrication, low-maintenance or maintenance-free spindles, i.e., those utilizing pre-lubed bearings that require little or no subsequent lubrication, are popular with end users. To provide protection from external contamination, these bearings are typically shielded by a metallic cap that, at least at the lower end of the spindle shaft, is compressively secured against an inner race of the lowest bearing. Because the cap is axially clamped to the spindle shaft, a small gap between an outer edge of the cap and the spindle housing is provided to accommodate clearance for cap rotation.

While these metallic caps are effective at reducing the ingress of debris during mower operation, potential problems remain. For example, the underside of the cutting deck is often cleaned with a pressure washer system. These systems may generate a high pressure stream that may result in water ingress through the gap between the metallic cap and the spindle housing. Depending on water pressure and gap size, some water may impinge upon the bearing itself. After repeated washings, such water intrusion may degrade the bearing lubricant, potentially leading to premature bearing wear.

### SUMMARY

The present invention may overcome these and other issues by providing a labyrinth seal and a spindle assembly incorporating the same. For example, in one embodiment, a spindle assembly is provided that includes a spindle housing having a first end and a second end, wherein a passageway extends from the first end to the second end. A spindle shaft is also included and is positioned within the passageway of the spindle housing. A bearing may be positioned within an annular space formed between the spindle shaft and the spindle housing. A stepped seal may be secured to either the spindle shaft or the housing and positioned within the passageway at a location that is both: near the first end of the housing; and spaced-apart from the bearing.

In another embodiment, A spindle assembly is provided that includes a spindle housing having a first end and a second end, wherein a passageway extends through the housing from the first end to the second end, and wherein the passageway defines a longitudinal axis. Also included are: a spindle shaft positioned within the passageway of the spindle housing along the longitudinal axis; and two bearings spaced-apart along the longitudinal axis, the two bearings each positioned within an annular space formed between the spindle shaft and the spindle housing, the two bearings configured to permit the spindle shaft to rotate relative to the spindle housing. A cylindrical seal may be provided that is radially and axially secured within a groove formed in an outer surface of the spindle shaft at a location near the first end of the housing. The seal includes a cylindrical outer surface defining two steps when viewed normal to the longitudinal axis.

In yet another embodiment, a lawn mower cutting deck is provided that includes: an enclosure defining a cutting chamber, the enclosure having an upper surface; and one or more spindle assemblies. Each spindle assembly may include a spindle housing configured to attach to the enclosure at the upper surface. The housing may include a first end and a second end, wherein a passageway defining a longitudinal axis extends from the first end to the second end. The spindle assembly may also include: a spindle shaft positioned within the passageway of the spindle housing along the longitudinal axis; and two bearings spaced-apart along the longitudinal axis. The two bearings may each be positioned within an annular space formed between the spindle shaft and the spindle housing. Further, the two bearings may be configured to permit the spindle shaft to rotate relative to the spindle housing. The spindle assembly may further include a cylindrical seal both radially and axially secured within a groove formed in an outer surface of the spindle shaft at a location that is both: near the first end of the housing; and spaced-apart from each of the two bearings. The seal may include a cylindrical outer surface that is stepped when viewed normal to the longitudinal axis.

The above summary is not intended to describe each embodiment or every implementation of the present invention. Rather, a more complete understanding of the invention will become apparent and appreciated by reference to the following Detailed Description of Exemplary Embodiments and claims in view of the accompanying figures of the drawing.

### BRIEF DESCRIPTION OF THE VIEWS OF THE DRAWING

The present invention will be further described with reference to the figures of the drawing, wherein:

FIG. 1 is a top perspective view of a machine, e.g., a power lawn mower with cutting deck, incorporating a spindle assembly in accordance with one embodiment of the invention;

FIG. 2 is a lower perspective view of the mower and cutting deck of FIG. 1 illustrating one or more spindle assemblies in accordance with one embodiment of the invention;

FIG. 3 is a section view taken through a plane containing a longitudinal axis of one spindle assembly, e.g., along line 3-3 of FIG. 2;

FIG. 4 is an enlarged section view illustrating a lower portion of the spindle assembly of FIG. 3;

FIG. 5 is an enlarged section view illustrating an upper portion of the spindle assembly of FIG. 3;

FIG. 6 is a diametric section view of a labyrinth seal in accordance with one embodiment of the invention;

FIG. 7 is a perspective view of the labyrinth seal of FIG. 6;

FIG. 8 is a section view of a portion of a spindle assembly in accordance with another embodiment of the invention; and

FIG. 9 is a section view of a known spindle assembly configuration.

The figures are rendered primarily for clarity and, as a result, are not necessarily drawn to scale.

### DETAILED DESCRIPTION OF EXEMPLARY EMBODIMENTS

In the following detailed description of illustrative embodiments of the invention, reference is made to the accompanying figures of the drawing which form a part hereof, and in which are shown, by way of illustration, specific embodiments in which the invention may be practiced. It is to be understood that other embodiments may be utilized and structural changes may be made without departing from the scope of the present invention.

Generally speaking, embodiments of the invention, as described herein, are directed to spindle assemblies operable to support a rotating member. For example, embodiments of the present invention are illustrated and described herein in the context of spindle assemblies for use with connecting a lawn mower cutting blade to a cutting deck, and to cutting decks and mowers incorporating the same. Such spindle assemblies may be rotationally attached to a cutting deck housing such that rotational energy may be transmitted from a power source, e.g., from an engine, to the cutting blade when the latter is operatively attached to the spindle assembly. However, while described herein in terms of a spindle assembly for use with a cutting deck, such applications are not limiting as embodiments of the present invention may find application to most any spindle application (e.g., to other deck and mower applications, as well as to other spindle machines).

Spindle assemblies in accordance with embodiments of the instant invention may incorporate a unique shield or seal capable of securing to a spindle shaft of the spindle assembly by providing an interference fit between the seal and an outer surface of the shaft. As the seal may be securely located via radial interference with the shaft, axial compression of the seal relative to a bearing of the spindle assembly is not required to secure the seal in place. As a result, the seal may be constructed as a flexible element (as opposed to the rigid metallic caps known in the art). Moreover, because axial compression of the seal is not required, it may be positioned at a location that is spaced-apart from each bearing, a configuration that provides various benefits as further described herein.

As used herein, the term “axial” refers to a direction along the longitudinal axis of the spindle shaft. Further, the term “radial” may refer to a direction that is radial (orthogonal) to the longitudinal axis of the shaft.

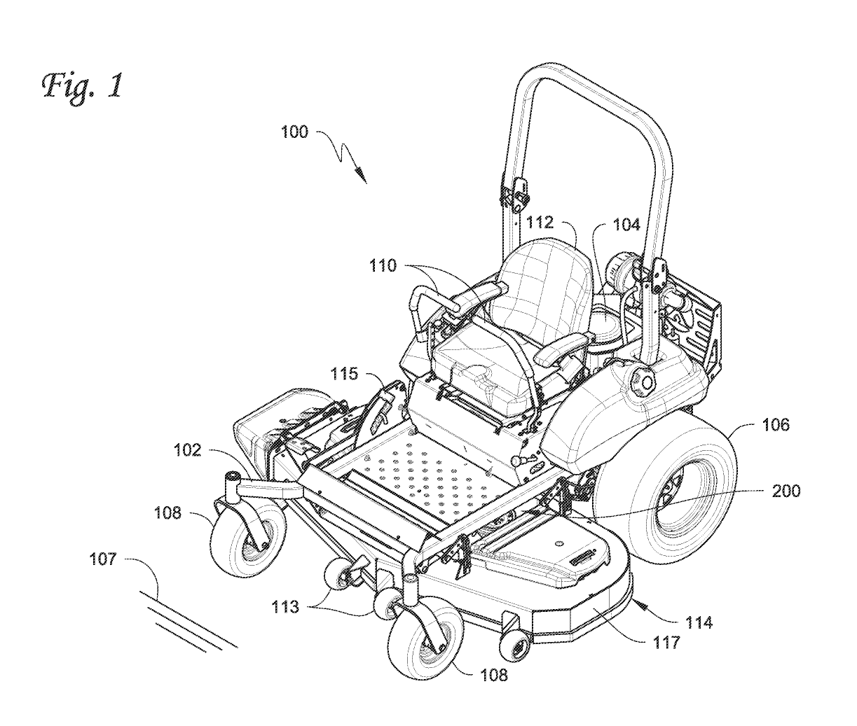

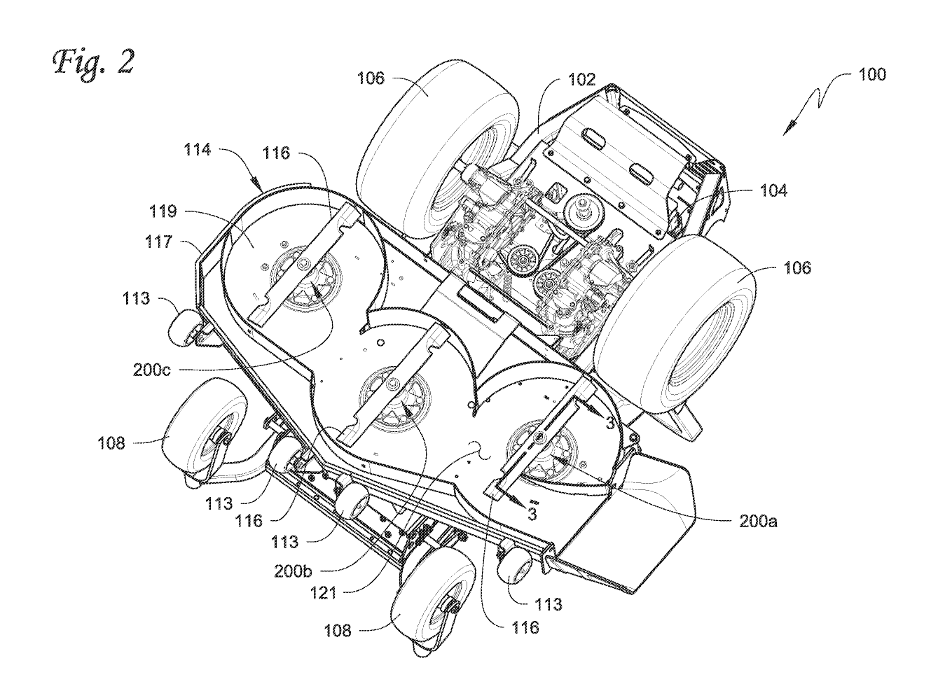

FIGS. 1 and 2 illustrate a blade driver spindle assembly 200 (see FIG. 2) in accordance with one embodiment of the present invention as it may be incorporated on a cutting deck of a self-propelled, ground maintenance vehicle, e.g., a zero-radius-turning (ZRT) riding lawn mower 100 (also referred to herein simply as a “mower”). The illustrated embodiment utilizes a three-spindle deck configuration having spindle assemblies 200a, 200b, and 200c (the spindle assemblies are generally identical to each other and may thus be referred to individually and/or collectively as “spindle assembly (or assemblies) 200”). However, this is not limiting as cutting decks incorporating most any number of spindles are contemplated. Moreover, while the invention is herein described with respect to a riding mower, those of skill in the art will realize that the invention is equally applicable to other types of mowers (e.g., towed, walk-behind, etc.), as well as to other types of power equipment.

The general mower configuration, although not necessarily central to an understanding of embodiments of the invention, is now briefly described. FIGS. 1 and 2 clearly illustrate the mower 100 having a frame 102 supporting a prime mover, e.g., internal combustion engine 104. Left and right ground engaging drive wheels 106 may be rotatably coupled to left and right sides of a rear portion of the mower 100. The drive wheels 106 may be independently powered by the engine (e.g., via one or more hydraulic motors, transmissions, or the equivalent) so that the drive wheels 106 may selectively propel the mower 100 over a ground surface 107 during operation.

One or more controls, e.g., left and right drive control levers 110 may also be provided. The drive control levers 110 are generally pivotally coupled to the mower such that they may pivot forwardly and rearwardly under the control of an operator sitting in an operator's seat 112. The drive control levers 110 are operable to independently control speed and direction of their respective drive wheels 106 via manipulation of the mower's drive system as is known in the art. While illustrated herein as incorporating separate drive control levers 110, other controls, e.g., single or multiple joysticks or joystick-type levers, steering wheels, etc. may also be used without departing from the scope of the invention. As shown herein, a pair of front swiveling caster wheels 108 may support a front portion of the mower 100 in rolling engagement with the ground surface 107 during operation.

A lawn mower cutting deck 114 may be mounted to the lower side of the frame 102, e.g., generally between the drive wheels 106 and the caster wheels 108. The cutting deck 114 may include a deck housing 117 that defines an enclosure forming a cutting chamber 119. The cutting chamber 119 may partially surround one or more rotatable cutting blades 116 each attached to a spindle assembly 200.

During operation, power is selectively delivered to the cutting deck 114 (e.g., to the spindle assemblies 200) and the drive wheels 106, whereby the cutting blades 116 rotate at a speed sufficient to sever grass and other vegetation as the deck passes over the ground surface 107. Typically, the cutting deck 114 has an operator-selectable height-of-cut control 115 (see FIG. 1) to allow deck height adjustment relative to the ground surface 107. The cutting deck 114 may optionally include anti-scalp rollers 113 to assist in reducing blade/ground contact (see also FIG. 1). Other miscellaneous controls may also be included to permit operator control of specific mower functions, e.g., throttle, blade engagement, etc.

Other aspects/features of the mower 100, e.g., those that are either not central to an understanding of the illustrative embodiments of the invention or are readily known by those skilled in the art, may also be included. However, such other aspects/features may not be further described and/or illustrated herein.

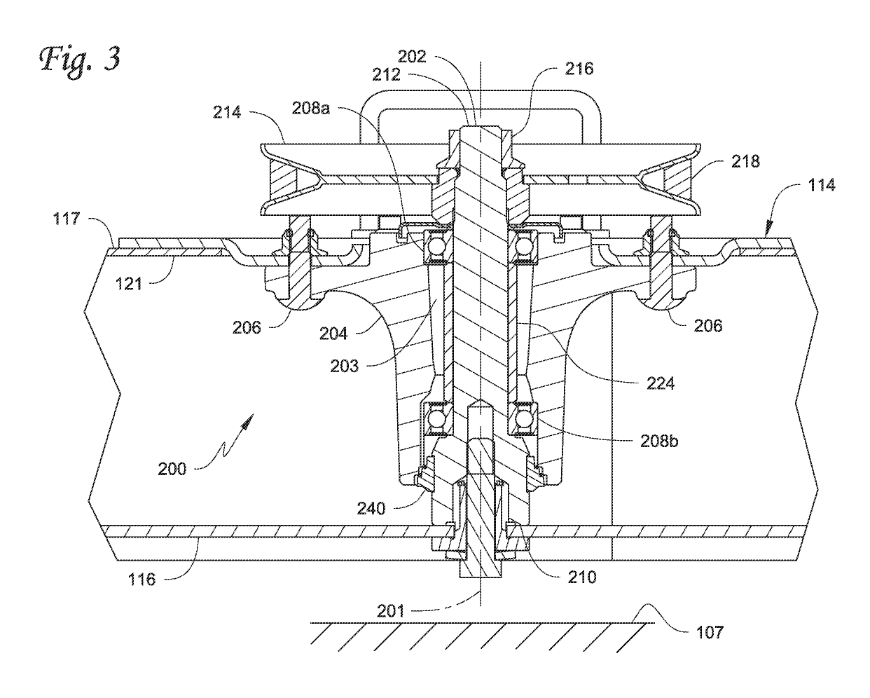

FIG. 3 is a partial section view of the deck 114 and one of the spindle assemblies 200 (e.g., spindle assembly 200a) taken along a plane that is parallel to a longitudinal axis of the mower (e.g., along the line 3-3 of FIG. 2) and contains a vertical longitudinal axis 201 of the assembly 200a. As illustrated in this view, each spindle assembly 200 may include a spindle shaft 202 that is positioned along the axis 201 for rotation within a passageway 203 defined by a spindle housing 204 that is itself attached (e.g., with fasteners 206) to an upper (e.g., horizontal) surface 121 of the deck housing 117. The passageway 203 may extend from a first end of the housing 204 to a second end as shown in the figures. The spindle housing 204 may include two or more bearings 208 (upper bearing 208a and lower bearing 208b). The bearings 208 may be spaced-apart along the axis 201 of the spindle shaft 202 (within the passageway 203) and within an annular space formed between the spindle shaft and the spindle housing 204. The bearings 208 are configured to permit rotation of the spindle shaft 202 relative to the spindle housing 204 in a conventional manner. While illustrated with two bearings, other embodiments could utilize more or less bearings (e.g., a single bearing or three or more bearings), where such a configuration could be advantageous to the particular application, without departing from the scope of the invention.

The spindle shaft 202 may include a first (e.g., lower) end 210 proximate the ground surface 107. The first end 210 may include blade coupling features that permit attachment of the blade 116 to the spindle shaft 202 such that the two components rotate together. One exemplary blade coupler is described in more detail in U.S. Pat. Pub. No. 2007/0006562.

A driven sheave 214 may be attached to a second (e.g., upper) end 212 of the spindle shaft 202 and secured thereto, e.g., with a nut 216. A drive connection, e.g., splines, may secure the sheave 214 to the shaft 202 to permit transmission of rotational power from a drive belt 218 to the cutting blade 116. While described and illustrated as a sheave, other embodiments could use most any other power transmission device (e.g., sprocket, timing belt, gear, coupling, etc.) without departing from the scope of the invention.

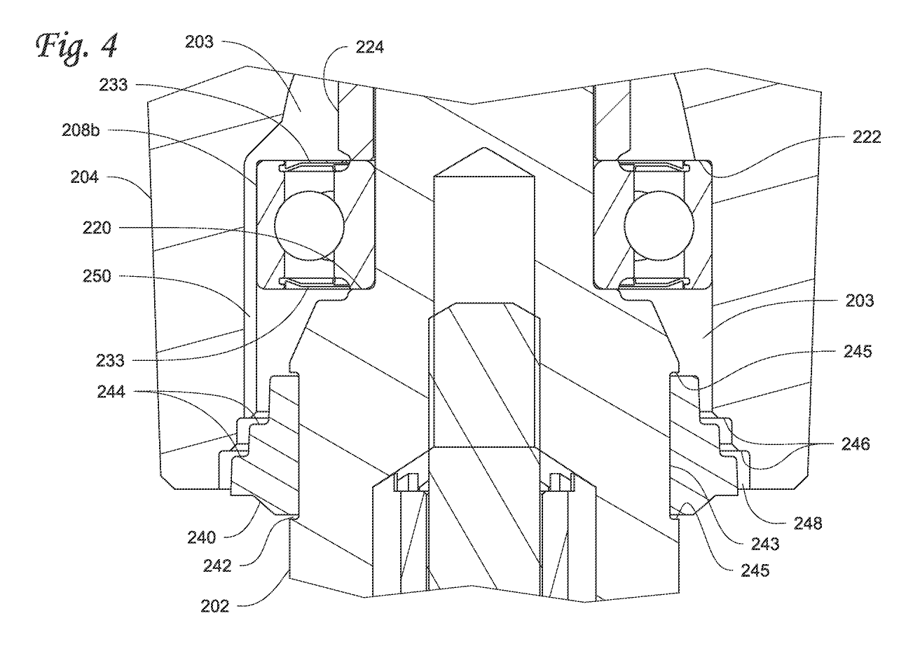

With reference to FIG. 4, the spindle shaft 202 may form a shoulder 220 configured to abut an inner race of the lower bearing 208b when assembled. Similarly, the spindle housing 204 may define a shoulder 222 configured to abut an outer race of the lower bearing.

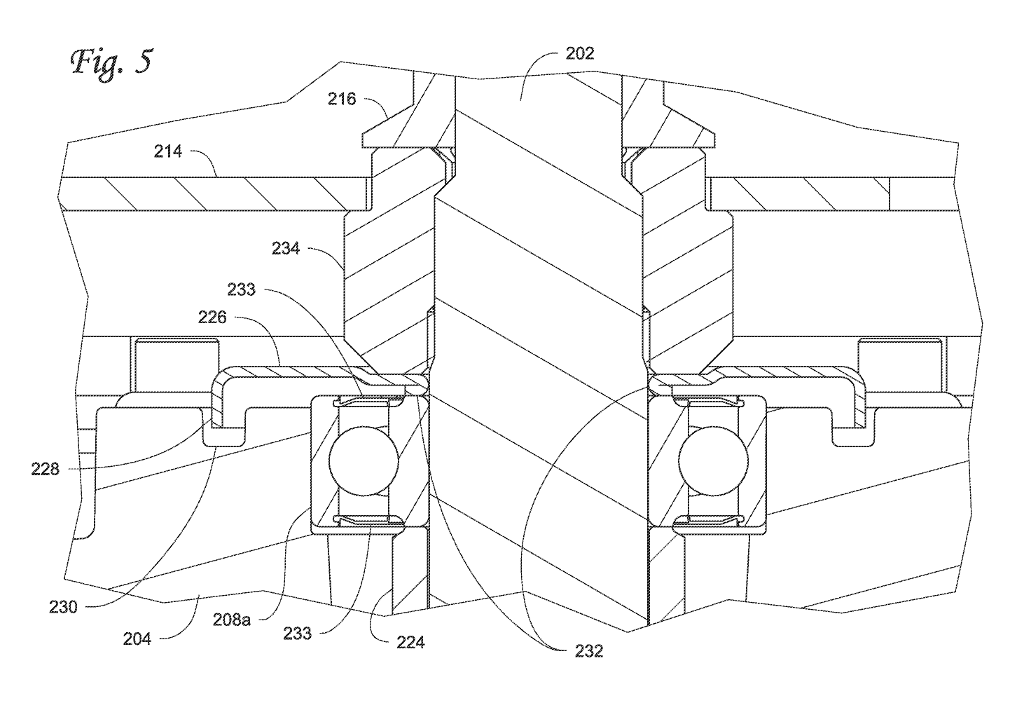

A spacer sleeve 224 (see also FIG. 3) may be used to space the upper bearing 208a at the desired distance from the lower bearing 208b. In the illustrated embodiment, the sleeve 224 may bear against the inner race of each of the bearings as shown (see also FIG. 5).

FIG. 5 illustrates an upper portion of the exemplary spindle assembly 200. As shown in this view, a metallic shield 226 may be positioned over the upper bearing 208a to limit debris entry into the bearing. The shield may have a disk-shaped (annular) body and a flange 228 around its periphery that is received within a groove 230 of the housing 204 when assembled. An inner edge 232 of the shield 226 may extend inwardly to a point at or near the outer surface of the shaft 202. The inner edge 232 may, when the nut 216 is tightened, be clamped against the inner race of the upper bearing 208a via a hub portion 234 of the sheave 214. The metallic shield 226 may provide an effective barrier for limiting entry of debris into the upper bearing 208a from above the deck 114.

In one embodiment, the inner edge 232 of the shield may be rolled 180 degrees so that a portion of the shield extends radially outwardly towards the flange 228 as shown in FIG. 5. Such a construction may, for example, provide desirable clearance between the body of the rotating shield 226 and an adjacent seal 233 of the upper bearing. This clearance is beneficial as, for example, the bearing may “breath” during operation. This breathing may cause the bearing seal 233 to push or distend outwardly (upwardly). A similar clearance may be provided on the underside of the upper bearing 208a (e.g., via the sleeve 224), as well as on each side of the lower bearing 208b (e.g., via the sleeve 224 and the spindle 202 as shown in FIG. 4).

A shield may also be provided to protect entry of debris from the lower side of the deck 114. In one embodiment, this lower shield is configured as a cylindrical “labyrinth” or stepped seal 240 positioned at or near the first (e.g., lower) end of the spindle housing 204 as perhaps best shown in FIGS. 3, 4 and 6-7. While the seal 240 may be made of various, e.g., nonmetallic, materials, it is in one embodiment constructed of a resilient, flexible polymeric material such as nylon (e.g., RTP 299 from RTP Company of Winona, Minn., USA) or a similar polymer. While shown at only one (e.g., lower) end of the spindle housing, other embodiments may locate a seal in accordance with embodiments of the present invention (e.g., the seal 240 or the seal 440 (described elsewhere herein)) near either or both ends of the housing without departing from the scope of the invention.

The seal 240 may be configured to deflect sufficiently to fit over a head (e.g., lower end 210) of the shaft 202 where it may seat within a groove 242 formed in the shaft as shown in FIG. 4. To assist with ease of seal installation, the shaft (e.g., shaft head) may be slightly tapered. Once positioned within the groove 242, the resilience of the seal 240 ensures that the seal (e.g., its inner surface) maintains an interference fit with the outer surface of the shaft (e.g., an outer, recessed surface 243 of the groove 242) such that the seal is radially secured to, and rotates with, the shaft. By securing to the shaft radially (as opposed to securing via axial compression between the shaft head and the lower bearing 208b), the seal 240 may be positioned within the passageway 203 and along the shaft independent of the location of the bearing. For example, in the illustrated embodiment, the seal is axially positioned outside of, (e.g., beyond) and spaced-apart from, the two bearings 208. The structure of the groove 242 may further permit axial positioning and securing of the seal as indicated in FIG. 4. For example, in the illustrated embodiment, the seal 240 is, when assembled to the spindle assembly, axially restrained only by contact with side surfaces of the groove (e.g., with the surfaces 245).

In the illustrated embodiment, the inner surface of the seal 240 is defined by a constant diameter extending longitudinally from a first end to a second end of the seal, i.e., the inner surface of the seal may be defined by a uniform diameter. However, while an outer surface of the seal 240 is also cylindrical, it may include one or more, e.g., two, steps 244 when viewed normal to the longitudinal axis 201 (see, e.g., FIG. 4). These steps 244 correspond to, but are offset from, similar steps 246 formed along an inner surface of the passageway 203 of the housing 204. The seal (when assembled with the shaft 202) may then be received with radial clearance within the passageway 203. This construction may yield a radial and axial gap or clearance 248 between the seal and the housing (e.g., between the outer surface of the seal and the inner surface of the passageway 203) that is stepped or irregular, e.g., forms a tortuous path or “labyrinth” passage as indicated in FIG. 4. To ensure that the seal 240 may rotate with the spindle shaft 202 without contacting the housing 204, the gap 248 (measured radially) may, in one embodiment, be about 0.08 inches to about 0.12 inches. In other embodiments, it is contemplated that the seal could have little or no gap when installed, but wear sufficiently during operation to ultimately provide the desired gap.

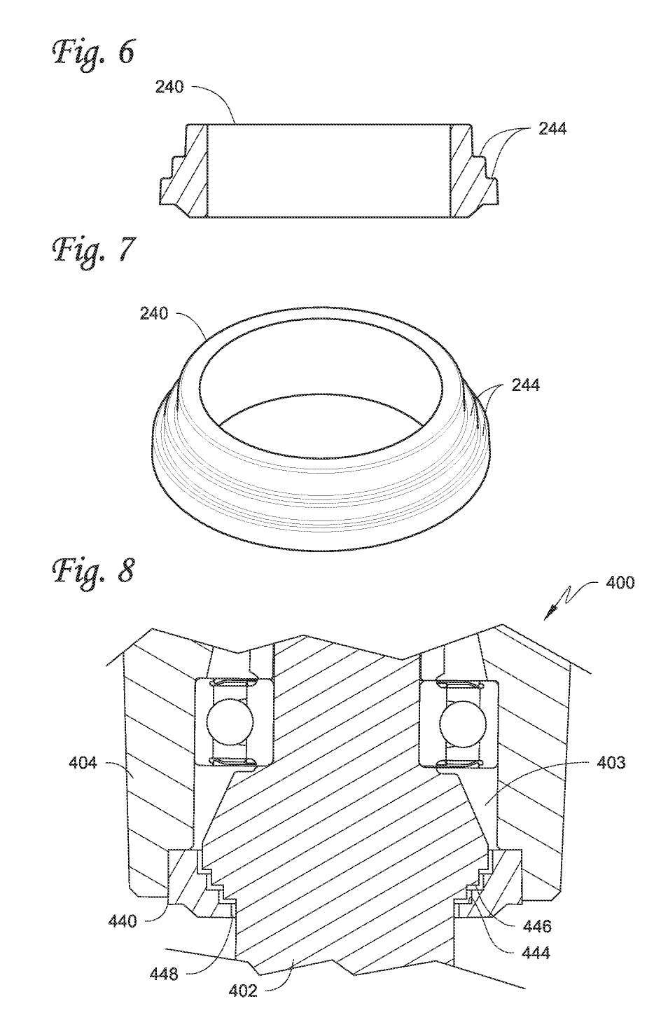

As used herein, a “step” (e.g., “stepped seal”) may be defined by a first (e.g., horizontal) surface intersecting orthogonal second (e.g., vertical) surfaces such that the structure appears like a common step or staircase. While described as intersecting orthogonally, other embodiments may include stepped surfaces intersecting at other angles without departing from the scope of the invention. Moreover, embodiments wherein the cross- sectional shape of the outer seal edge includes curved segments (e.g., producing a serpentine shape) forming the step(s) are also contemplated. In fact, most any configuration that provides the desired clearance or gap between the seal and the housing while also preventing direct “line-of-sight” from outside the seal into the passageway 203 is contemplated. In the case of a cylindrical item such as the stepped seal 240 illustrated in the figures, the step-forming surfaces are clearly visible when the seal is viewed in cross section (see FIGS. 4 and 6). While two steps are illustrated in the figures, other configurations may utilize more (e.g., three steps) or less (e.g., one step) without departing from the scope of the invention.

While shown and described as attaching the seal directly to the shaft, other embodiments are contemplated wherein the seal could be attached to the housing as is diagrammatically illustrated, for example, with the spindle assembly 400 shown in FIG. 8. In such an embodiment, an outer diameter of a stepped seal 440 could be received with clearance (or with a slight interference fit) within a pocket formed near one or both ends of a housing 404. A seal retainer (not shown) could be used to secure the seal in place. The seal 440 could include at least one step 444 formed along its inner diameter that corresponds with one or more steps 446 formed on the outer diameter of the spindle 402. As a result, a tortuous path 448 (like the clearance 248 already described herein with respect to the spindle assembly 200) could again be defined between the outer side of the seal and the passageway 403. The spindle assembly 400 is otherwise similar to the spindle assembly 200 already described herein.

Referring again primarily to FIG. 4, the housing 204 may, in one embodiment, include one or more, e.g., three longitudinal grooves 250 formed in the inner surface of the passageway 203 (only one groove is visible in this section view, but more could be spaced around the circumference). The grooves 250 may extend from above an uppermost edge of the bearing (e.g., above the lower bearing 208b) downwardly to or past the step(s) 246 (such that it breaks through the uppermost step 246). These grooves 250 may allow pressure build-up and/or moisture (e.g., condensation) formed between the two bearings 208 to release or drain from the housing 204 without undesirably distending the bearing seals 233 and/or expelling the bearing lubricant. Moreover, these grooves may provide minimal area to water stream ingress (e.g., from cleaning) that may try to enter the passageway 203.

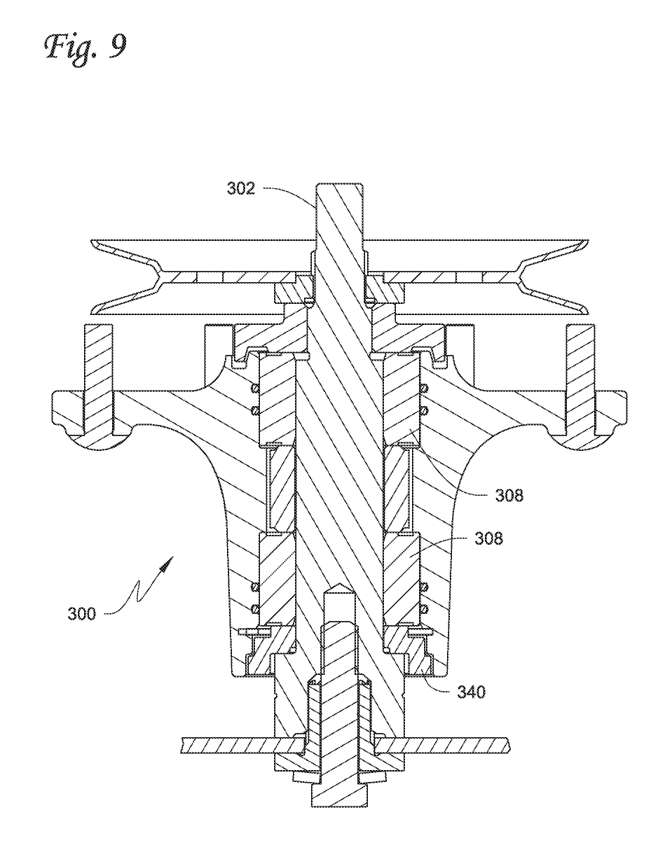

A spindle assembly having a construction as exemplified herein may provide numerous advantages over other spindle assemblies such as the assembly 300 shown in FIG. 9. For example, by securing the shield or seal 240 radially to the shaft 202 (instead of axially against the bearing as with the metallic shield 340/bearing 308 and associated shaft 302 of FIG. 9), the seal 240 may be located axially away from the lower bearing 208a. That is, the seal may be spaced-apart from the lower bearing as shown in FIG. 4, as opposed to being pressed directly against the race of the bearing. As a result, when the underside of the deck 114 is subjected to a high pressure water stream, any water that is forced past the seal 240 and enters the passageway 203 has a greater distance over which to dissipate its kinetic energy before reaching the bearing 208. As a result, the ability of such water to traverse the bearing lip seal, and ultimately enter the bearing, may be substantially reduced. Furthermore, the tortuous path that water would need to traverse to reach the bearing may further reduce water ingress to the bearing.

Still further, by moving the seal 240 out of the bearing stack, more axial distance may be provided, allowing the bearings 208a and 208b to be spaced further apart. Such increased spacing may improve bearing capacity and, accordingly, bearing life. The seal 240 may also have less rotational mass than a corresponding metallic shield, and potentially be manufactured more cost effectively. Moreover, by constructing the seal 240 from a flexible (rather than a rigid) material, looser tolerances (e.g., on the spindle housing) may be accommodated, which may potentially further reduce cost.

If the lower bearing were to fail, the use of a flexible seal 240 such as described herein may provide yet additional benefits. For example, since the seal 240 is relatively soft, it may become a sacrificial component, potentially isolating the housing 204 from damage that may otherwise result if contacted by a rotating metallic shield (such as the shield 340 shown in FIG. 9).

The complete disclosure of the patents, patent documents, and publications cited in the Background, the Detailed Description of Exemplary Embodiments, and elsewhere herein are incorporated by reference in their entirety as if each were individually incorporated.

Illustrative embodiments of this invention are discussed and reference has been made to possible variations within the scope of this invention. These and other variations, combinations, and modifications will be apparent to those skilled in the art without departing from the scope of the invention, and it should be understood that this invention is not limited to the illustrative embodiments set forth herein. Accordingly, the invention is to be limited only by the claims provided below and equivalents thereof.

What is claimed is:

1. A spindle assembly comprising:
a spindle housing comprising a first end and a second end, wherein a passageway extends from the first end to the second end;
a spindle shaft positioned within the passageway of the spindle housing;
a bearing positioned within an annular space formed between the spindle shaft and the spindle housing; and
a stepped seal secured to either the spindle shaft or the housing and positioned within the passageway at a location that is both: near the first end of the housing; and spaced-apart from the bearing.

2. The assembly of claim 1, wherein the seal, when assembled with the spindle assembly, is axially located and restrained only by contact with a groove formed in the spindle shaft.

3. The assembly of claim 1, wherein the seal comprises a nonmetallic material.

4. The assembly of claim 1, wherein the seal comprises a resilient polymeric material.

5. The assembly of claim 1, wherein the seal is received with radial and axial clearance within the passageway such that a gap exists between an outer surface of the seal and an inner surface of the passageway.

6. The assembly of claim 5, wherein the seal comprises at least two steps and the passageway comprises corresponding steps such that the gap forms a tortuous path.

7. The assembly of claim 1, wherein the bearing includes first and second bearings located within the passageway, and wherein the seal is positioned axially along the spindle shaft at a location spaced-apart from each of the two bearings.

8. The assembly of claim 1, wherein the seal is secured to the spindle shaft via an interference fit between an inner surface of the seal and an outer surface of the spindle shaft.

9. The assembly of claim 8, wherein the outer surface of the spindle shaft defines a groove configured to axially locate and secure the seal relative to the spindle shaft.

10. The assembly of claim 8, wherein a first end of the spindle shaft is tapered to accommodate installation of the seal onto the spindle shaft.

11. A spindle assembly comprising:
a spindle housing comprising a first end and a second end, wherein a passageway extends through the housing from the first end to the second end, the passageway defining a longitudinal axis;
a spindle shaft positioned within the passageway of the spindle housing along the longitudinal axis;
two bearings spaced-apart along the longitudinal axis, the two bearings each positioned within an annular space formed between the spindle shaft and the spindle housing, the two bearings configured to permit the spindle shaft to rotate relative to the spindle housing; and
a cylindrical seal radially and axially secured within a groove formed in an outer surface of the spindle shaft at a location near the first end of the housing, wherein the seal comprises a cylindrical outer surface defining two steps when viewed normal to the longitudinal axis.

12. The assembly of claim 11, wherein the seal is secured to the spindle shaft via an interference fit between an inner surface of the seal and a surface of the groove.

13. The assembly of claim 12, wherein the inner surface of the seal is defined by a constant diameter extending longitudinally from a first end of the seal to a second end of the seal.

14. The assembly of claim 11, further comprising a cutting blade attached to the first end of the spindle shaft.

15. The assembly of claim 11, further comprising a spacer sleeve positioned between the two bearings.

16. The assembly of claim 11, wherein the seal comprises a nonmetallic material.

17. The assembly of claim 11, wherein the seal comprises a resilient polymeric material.

18. A lawn mower cutting deck comprising:
an enclosure defining a cutting chamber, the enclosure comprising an upper surface; and
one or more spindle assemblies, wherein each spindle assembly comprises:
a spindle housing configured to attach to the enclosure at the upper surface, the housing comprising a first end and a second end, wherein a passageway defining a longitudinal axis extends from the first end to the second end;
a spindle shaft positioned within the passageway of the spindle housing along the longitudinal axis;
two bearings spaced-apart along the longitudinal axis, the two bearings each positioned within an annular space formed between the spindle shaft and the spindle housing, the two bearings configured to permit the spindle shaft to rotate relative to the spindle housing; and
a cylindrical seal both radially and axially secured within a groove formed in an outer surface of the spindle shaft at a location that is both:
near the first end of the housing; and spaced-apart from each of the two bearings, the seal comprising a cylindrical outer surface that is stepped when viewed normal to the longitudinal axis.

19. The deck of claim 18, wherein the passageway of the housing comprises an inner surface that is stepped to correspond to, but be offset from, the stepped outer surface of the seal so that a stepped gap is formed between the outer surface of the seal and the inner surface of the passageway.

20. The deck of claim 18, further comprising a cutting blade attached to the first end of the spindle shaft and a sheave attached to the second end of the spindle shaft.
